(19) United States
(12) Patent Application Publication
(10) Pub. No.: US 2025/0110505 A1
(43) Pub. Date: Apr. 3, 2025

(54) VARIABLE BLOCK RISK ASSESSMENT FOR AUTONOMOUS AIRCRAFT ROUTING

(71) Applicant: Skyway Technologies Corp., San Rafael, CA (US)

(72) Inventors: Clifford Fernandez, New York, NY (US); Derrick Lewis, New York, NY (US)

(21) Appl. No.: 18/900,265

(22) Filed: Sep. 27, 2024

Related U.S. Application Data
(60) Provisional application No. 63/586,056, filed on Sep. 28, 2023.

(51) Int. Cl. G05D 1/617; G05D 1/46; G05D 101/00; G05D 109/20

(52) U.S. Cl. CPC G05D 1/621; G05D 1/46; G05D 2101/22; G05D 2109/20

(57) ABSTRACT

Systems and methods for creating and optimizing air travel routes and corridors, such as routes and/or corridors for unmanned aircraft, are described. For example, the systems and methods may receive or access subsets of weather data, where each subset (e.g., a two-dimensional (2D) set of data) represents or characterizes a portion of the impact of a weather event (e.g., rain, wind) on a geographical location or navigation area. The systems and methods may process the subsets to generate distinct components (e.g., three-dimensional blocks) that are aligned with segments of the weather events, where the components are linked or mapped to a graphical representation of the target or affected location or region.

### CROSS REFERENCE TO RELATED APPLICATIONS

This application claims priority to U.S. Provisional Patent Application No. 63/586,056, filed on Sep. 28, 2023, entitled VARIABLE BLOCK RISK ASSESSMENT FOR AUTONOMOUS AIRCRAFT ROUTING, which is hereby incorporated by reference in its entirety.

### BACKGROUND

Aircraft, such as drones and other UAVs (unmanned aerial vehicles), vertical take-off and landing (VTOL) aircraft (e.g., electric VTOLs, such as eVTOLs), unmanned aircraft (UA), remotely piloted aircraft (RPA), and so on, have many different uses, including surveillance, package delivery, remote sensing, exploration and monitoring of locations, construction/surveying applications, and so on. While the control and management of individual aircraft can be managed, scenarios that utilize many different aircraft (from different entities) can introduce complexities and issues relating to the utilization, navigation, and/or management of aircraft (or groups or fleets of aircraft), among other drawbacks.

### BRIEF DESCRIPTION OF THE DRAWINGS

FIG. 1 is a diagram illustrating an aircraft traveling through a geographic location.

FIG. 2 is a block diagram illustrating a weather block system.

FIG. 3 is a flow diagram illustrating a method for performing an action based on weather at a geographic location.

FIG. 4 is a flow diagram illustrating a method for routing aircraft based on weather at a geographic location.

FIG. 5 is a block diagram illustrating the routing of aircraft via a flight window at a geographic location.

FIG. 6 is a flow diagram illustrating a method for routing aircraft through an open flight window at a geographic location.

In the drawings, some components are not drawn to scale, and some components and/or operations can be separated into different blocks or combined into a single block for discussion of some of the implementations of the present technology. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

### Overview

Often, adverse weather (e.g., rain, snow, wind, smoke, fog, and so on) affects a geographic location where aircraft are flying or otherwise traversing during operations. For example, a geographic location may have an ever-changing weather pattern, or predicted weather pattern, that can prevent or deter aircraft, such as unmanned aircraft, from flying during certain conditions (e.g., adverse or unsafe conditions) within the weather patterns.

Systems and methods for creating and optimizing air travel routes and corridors, such as routes and/or corridors for unmanned aircraft, are described herein. In some embodiments, the systems and methods seamlessly integrate real-time flight or route scheduling and ticketing with the created or optimized routes and corridors for aircraft.

For example, the systems and methods may receive or access subsets of weather data, where each subset (e.g., a two-dimensional (2D) set of data) represents or characterizes a portion of the impact of a weather event (e.g., rain, wind) on a geographical location or navigation area. The systems and methods may process the subsets to generate distinct components (e.g., three-dimensional blocks) that are aligned with segments of the weather events, where the components are linked or mapped to a graphical representation of the target or affected location or region.

Thus, as the subsets are processed, the systems and methods can build a three-dimension (3D) representation (e.g., one or more 3D blocks) of a weather event, which can be monitored and/or utilized, in real-time, by various systems associated with aircraft travel. For example, flight support systems, route or course planning and correction systems, flight operations, flight safety systems, and so on, may utilize the 3D representations to modify or enhance their real-time or future operations. For example, a real-time weather data processing system can include aspects when rendering an ever-changing graphical display and perform actions associated with advanced risk, alerting, avoidance intelligence, and so on.

In the following description, for the purposes of explanation, numerous specific details are set forth in order to provide a thorough understanding of implementations of the present technology. It will be apparent, however, to one skilled in the art that implementations of the present technology can be practiced without some of these specific details. The phrases “in some implementations,” “according to some implementations,” “in the implementations shown,” “in other implementations,” and the like generally mean the particular feature, structure, or characteristic following the phrase is included in at least one implementation of the present technology and can be included in more than one implementation. In addition, such phrases do not necessarily refer to the same implementations or different implementations.

### Examples of Assessing Risk for 3D Blocks at a Location

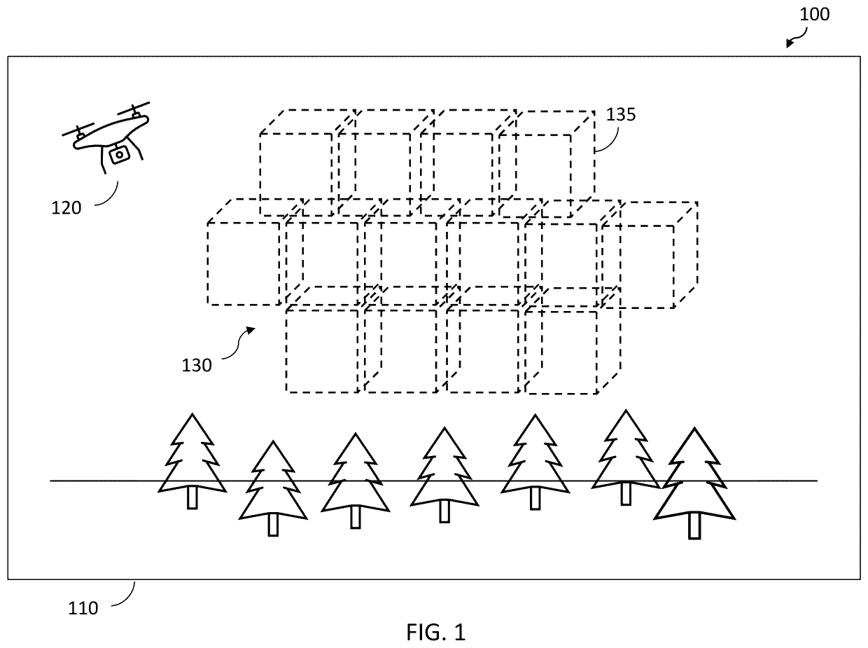

As described herein, the systems and methods utilize various sets, or subsets, or weather data to generate a 3D data block (or blocks) of weather information for certain or targeted geographic locations, regions, or areas. FIG. 1 is a diagram 100 illustrating an aircraft 120 traveling through a geographic location 110.

A set of 3D blocks of space 130 is associated with, and located within, the geographic location 110. For example, the set of 3D blocks of space 130 is positioned or located above a ground or base for the geographic location and positioned at a height that is within the flight paths of aircraft through the geographic location 110, such as the aircraft 120.

The set of 3D blocks of space 130 may include one or more individual 3D blocks 135. The 3D block 135 may be, for example, a geometrical shape in space (e.g., in the air above a ground location), such as a square or rectangle defined by a point in space (e.g., a point of origin defined as (lat, lon, altitude)) and a given size or constant (e.g., 50 feet, 100 feet, 25 meters, and so on). In some cases, the 3D block 135 can be other shapes that are located by a point of origin and a sizing variable or metric. Further, the set of 3D blocks of space 130 may include blocks of different sizes, shapes, and other varying characteristics. Thus, each block, for example, may be a digital twin of space at a location, such as a digital twin having a size that is 100 feet, or more.

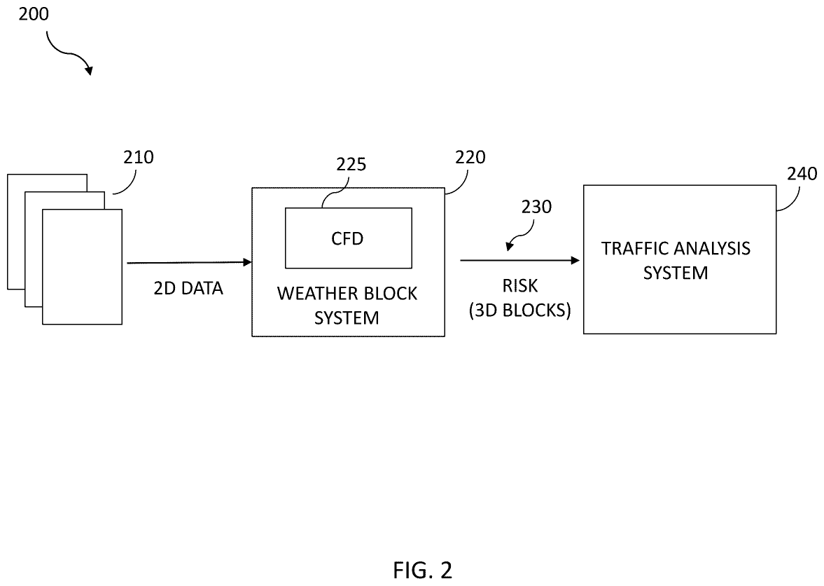

As described herein, the systems and methods generate the 3D blocks of space 130 to represent risk factors at the geographic location 110 that are based on adverse weather at (or predicted to be at) the geographic location 110. FIG. 2 is a block diagram 200 illustrating interaction of a weather block system 220 with data and analysis systems.

The weather block system 220 may access and/or receive two-dimensional (2D) weather data 210, such as various subsets of weather data for a location or region, to determine variable risk factors 230 or other metrics for three-dimensional (3D) blocks within the location or region. For example, the 2D weather data may include atmospheric data, wind data, precipitation data, lighting strike data, visibility data, temperature data, and so on.

In some cases, the weather block system 220 receives dimensional weather data 110 (e.g., 2D), such as data that represents a live forecast for an area via 2D data points. The weather block system 220, via a computational fluid dynamics (CFD) model, can determine, predict, or model a flow through one or more specific blocks using the 2D data sets, generating a 3D block.

For example, application of the CFD model 225 causes the weather block system 220 to generate or simulate how adverse weather is moving (or will move) through the geographic location 110. The weather block system 220 segments or otherwise parses the simulated flow (e.g., a 3D representation) into discrete 3D blocks, and assigns a risk factor to each of the 3D blocks (e.g., the 3D block 135. Thus, the simulated flow can be segmented into a group or set of multiple 3D blocks (e.g., the set of 3D blocks in space 130), each 3D having a unique or specific risk factor assigned to the 3D blocks. The risk factors may include various mathematical parameters, such as a set of risk score values that, when aggregated, result in an overall metric or parameters representative of the risk assigned to the block, and thus, the geographic area/location represented by the block.

Thus, the weather block system 220, utilizing outputs from the CFD model 225, can determine how weather may pass through the 3D blocks in three dimensions, and generate a risk metric or determination (e.g., risk factors or scores 230 for each 3D block 235, such as B1, B2, . . . , BN) for a location (e.g., such as the geographic location 210). In some cases, the CFD model 225, or the weather block system 220, can employ various machine learning or artificial intelligence models or techniques when generating risk metrics or factors for the 3D blocks.

A traffic analysis system 340 (or another system, as described herein) receives the risk factors 230 (e.g., risk scores) and performs actions for each of the 3D blocks and/or for the set of 3D blocks in space. For example, the traffic analysis system 240 can route aircraft (e.g., drones) through 3D blocks that have low risk scores (e.g., no adverse weather is predicted) and/or re-route aircraft away from a block or group of adjacent blocks assigned relatively higher risk scores (e.g., adverse weather is within the block or blocks at a time when the aircraft is expected to arrive). In some cases, a risk factor may include and/or be expressed as an open flight window, a closed flight window, and so on.

The weather block system 220 may be implemented with a combination of software (e.g., executable instructions, or computer code) and hardware (e.g., at least a memory and processor). Accordingly, as used herein, in some example embodiments, a component or module of the weather block system 220 is a processor-implemented module/component and represents a computing device having a processor that is at least temporarily configured and/or programmed by executable instructions stored in memory to perform one or more of the particular functions that are described herein.

In some embodiments, the weather block system 220 may include a data reception component configured to receive two-dimensional (2D) weather data for a geographic location, a block component configured to determine one or more risk factors for three-dimensional (3D) blocks of space associated with the geographic location, and an action component configured to perform an action associated with the 3D blocks of space.

As described herein, the action component may perform routing operations, mapping operations, and so on. For example, the action component may provide 3D blocks to various systems, (e.g., the traffic analysis system 240), causing the systems to perform the operations described herein. Further, the systems may incorporate aspects of the weather block system 220.

The action component, therefore, may modify the route, or cause the route to be modified, of one or more aircraft to pass through the 3D blocks of space when the one or more risk factors include low risk scores for the 3D blocks of space, and/or may modify the route, or cause the route to be modified, of one or more aircraft to avoid certain 3D blocks of space when the one or more risk factors include high risk scores for the 3D blocks of space. As another example, the action component performs a mapping operation (or causes performance of a mapping operation) to present a visual representation of the 3D blocks of space and the determined one or more risk factors for the geographic location.

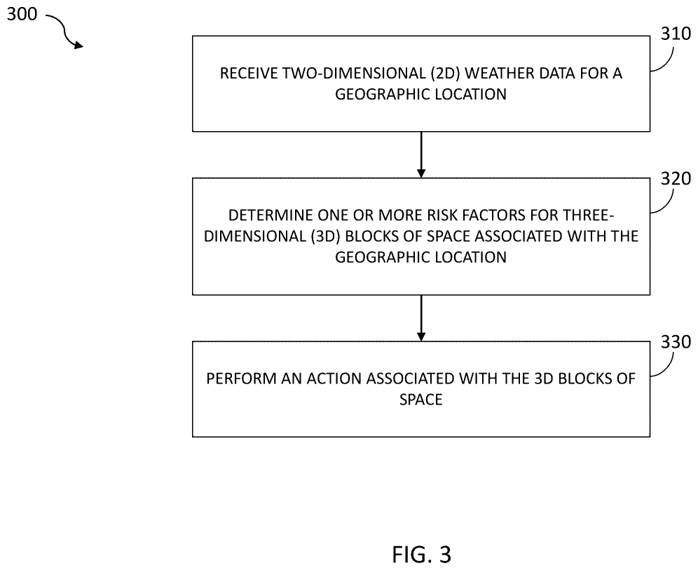

FIG. 3 is a flow diagram illustrating a method 300 for performing an action based on weather at a geographic location. The method 300 may be performed by the weather block system 220 and, accordingly, is described herein merely by way of reference thereto. It will be appreciated that the method 300 may be performed on any suitable hardware.

In operation 310, the weather block system 220 receives or accesses two-dimensional (2D) weather data for a geographic location. For example, a data reception component receives the two-dimensional (2D) weather data 210 for the geographic location 110.

In operation 320, the weather block system 220 determines one or more risk factors for three-dimensional (3D) blocks of space associated with the geographic location. For example, the block component determines one or more risk factors 230 for three-dimensional (3D) blocks of space associated with the geographic location 110.

In operation 330, the weather block system 220 performs an action associated with the 3D blocks of space. For example, the action component may modify or enhance a routing operation aircraft moving through the geographic location 110 and/or update a map of the geographic location 110 with visual elements that depict the determined risk factors for the geographic location 110.

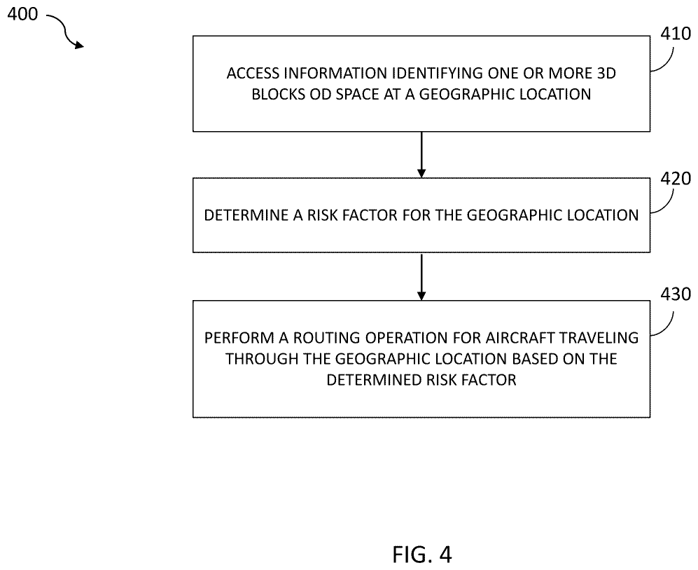

For example, the traffic analysis system 240 may utilize 3D block information determined by the system 220 to modify its flight traffic operations. FIG. 4 is a flow diagram illustrating a method 400 for routing aircraft based on weather at a geographic location. The method 400 may be performed by the traffic analysis system 240 and, accordingly, is described herein merely by way of reference thereto. It will be appreciated that the method 400 may be performed on any suitable hardware.

In operation 410, the traffic analysis system 240 accesses information identifying one or more three-dimensional (3D) blocks of space at a geographic location. For example, the information may include risk factors mapped to the 3D blocks of space.

In operation 420, the traffic analysis system 240 determines a risk factor for the geographic location based on the accessed information. For example, the system 240 may apply the CFD model 225 to the two-dimensional live forecast data to determine a 3D flow at the geographic location and generate the 3D blocks of space based on the determined 3D flow at the geographic location.

In operation 430, the traffic analysis system 240 performs a routing operation for aircraft traveling through the geographic location based on the determined risk factor. For example, the routing operation may include routing the aircraft through the 3D blocks of space when the determined risk factor is below a threshold risk factor associated with adverse weather at the geographic location or routing the aircraft away from the 3D blocks of space when the determined risk factor meets or is above a threshold risk factor associated with adverse weather at the geographic location.

Thus, the weather block system 220 can generate a 3D flow or depiction of weather (e.g., in real-time) represented by multiple 3D blocks for a geographic location and based on 2D data sets that provide weather data for different 2D layers within the block. The system 120 may then assess a risk or relative risk for each 3D block and provide risk analysis information to the traffic analysis system 240 or similar systems, which perform aircraft routing, navigation, control, and/or other actions.

### Examples of Determining a Flight Timing Window for a Location

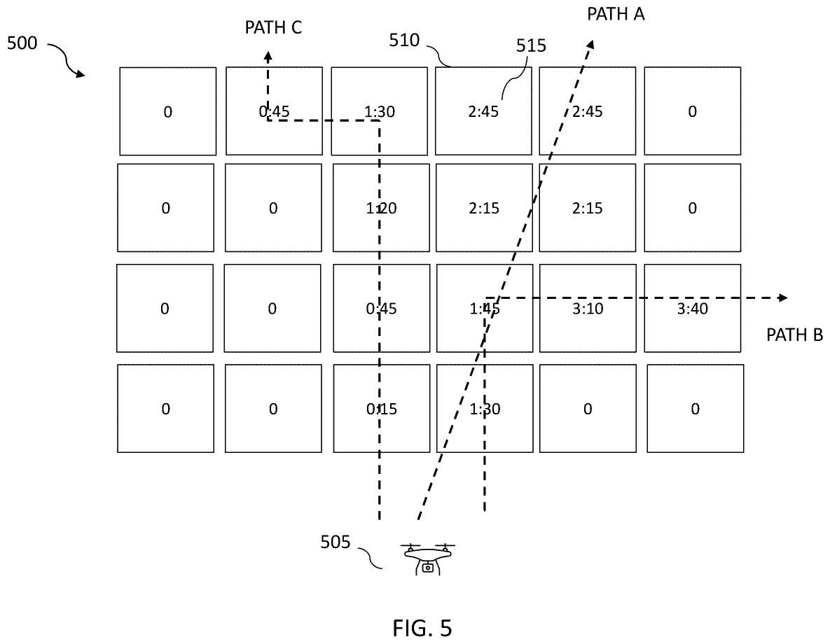

As described herein, in some embodiments, the systems and methods may determine and/or simulate a flight timing window for a location (e.g., the geographic location 110). FIG. 5 is a block diagram illustrating the routing of aircraft via a flight window 500 at a geographic location.

The flight window 500, as depicted, includes multiple blocks 510 or segments of space within a geographic location (e.g., the geographic location 110). The blocks 510, or segments, may be defined by a certain size (e.g., 25-100 feet) or area, may be various geometric shapes (e.g., squares, rectangles, and so on), may be 2D or 3D, may be positioned at different heights or layers, and so on.

Each of the blocks 510 may be associated with, or assigned, an open flight window or a closed flight window. For example, an open flight window signifies that an aircraft, such as aircraft 505, may fly through the geographic location via the block of space Similarly, a closed flight window signifies that the aircraft 505, may not fly through the geographic location via the block of space. The flight window 500, therefore, may be segmented into a set of blocks to form an open flight window and/or a closed flight window.

The flight window may be represented by or associated with a duration 515, such as an amount of time (e.g., a countdown time) within which the aircraft 505 is allowed to travel via the block or blocks. For example, a block having a window duration of “2:45” may indicate that the block is part of an open flight window for a next 2 hours and 45 minutes, a block having a window duration of “0:15” may indicate that the block is part of an open flight window for a next 15 minutes, and a block having a window duration of “0” may indicate that the block is part of a closed flight window.

In some cases, the duration 515 may be depicted with other metrics or indicators, such as binary indicators (e.g., open/closed), indicators associated with multiple blocks, and so on.

Various systems (e.g., the weather block system 220) may utilize the flight window 500 to schedule, control, route, and/or navigate aircraft, such as the aircraft 505, through a geographic location. For example, if the aircraft 505 travels at a certain speed that facilitates traveling through the flight window 500 within a next 30 minutes, the aircraft 505 may utilize any allowable paths (e.g., path A, path B, and path C) though a location. However, if the aircraft 505 travels at a lower speed, or is to remain with the location for 3 hours, the aircraft 505 may only utilize path B through the location, as that path contains end blocks having a flight window duration that exceeds 3 hours.

In some cases, as time progresses and/or weather conditions change, the values of the duration 515 for each of the blocks 510 may also change, where some blocks may change status from open to closed, and vice versa. For example, as a certain weather or environmental condition moves in one direction (e.g., a wind event moves eastward), a status or a block or group of blocks may be updated or modified as the weather condition moves through a location.

In some cases, a size or quantity of blocks for a geographic location may be based on a variety of factors or parameters, including an overall time window for routing aircraft through the geographic location, a type of aircraft to be routed through the geographic location, a quantity of aircraft to be routed through the geographic location, a weather forecast for the geographic location, and so on.

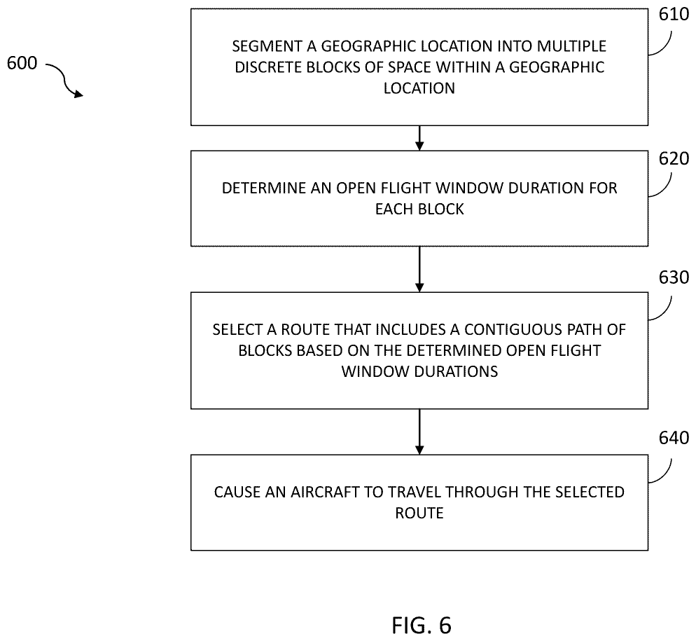

FIG. 6 is a flow diagram illustrating a method 600 for routing aircraft through an open flight window at a geographic location. The method 600 may be performed by the weather block system 220 and, accordingly, is described herein merely by way of reference thereto. It will be appreciated that the method 600 may be performed on any suitable hardware.

In operation 610, the weather block system 220 segments a geographic location into multiple discrete blocks of space within the geographic location. For example, the system 220 may generate a map overlay of multiple blocks for a geographic location.

In operation 620, the weather block system 220 determines an open flight window duration for each block of the multiple discrete blocks of space. For example, the system 220 may determine the duration 515 for each block 510 based on various risk factors or other weather conditions at the location.

In some cases, the system 220 may receive two-dimensional (2D) weather data for the geographic location and determine one or more risk factors for each block of the multiple discrete blocks of space. As described herein, the blocks of space may be three-dimensional blocks of space that represent a 3D flow through the geographic location that is determined by applying the computational fluid dynamics (CFD) model 225 to the 2D weather data 210 at the geographic location.

In operation 630, the weather block system 220 selects a route through the geographic location that includes a contiguous path of blocks within the geographic location based on the determined open flight window durations. For example, the system 220 selects one or more of the paths (e.g., path A or path C) based on the duration 515 for each block within the respective paths.

In operation 640, the weather block system 220 causes an aircraft to travel through the selected route. For example, the system 220 may cause a navigation system or routing operation to control the aircraft 505 to travel through the location via one or more of the paths associated with an open flight window for the aircraft 515.

### Example Embodiments of the Technology

As described herein, various embodiments may implement the technology described herein. In some embodiments, the systems and methods include a data reception component configured to receive two-dimensional (2D) weather data for a geographic location, a block component configured to determine one or more risk factors for three-dimensional (3D) blocks of space associated with the geographic location, and an action component configured to perform an action associated with the 3D blocks of space.

In some cases, the block component generates the 3D blocks of space by applying a computational fluid dynamics (CFD) model to the 2D weather data to determine a 3D flow at the geographic location and generating the 3D block based on the determined 3D flow at the geographic location.

In some cases, the 2D weather data for the geographic location includes multiple 2D data points representing a live forecast at the geographic location.

In some cases, the 3D blocks of space include at least one 3D block having a geometrical shape of space positioned within the geographic location.

In some cases, the geometrical shape of space is defined by a 3D point of origin and a size metric.

In some cases, the geometrical shape of space is defined by a specific shape and a size metric for the specific shape.

In some cases, the action component performs an aircraft routing operation based on the determined one or more risk factors for the 3D blocks of space.

In some cases, the aircraft routing operation modifies routes of one or more aircraft to pass through the 3D blocks of space when the one or more risk factors include low risk scores for the 3D blocks of space.

In some cases, the aircraft routing operation modifies routes of one or more aircraft to avoid the 3D blocks of space when the one or more risk factors include high risk scores for the 3D blocks of space.

In some cases, the action component performs a mapping operation to present a visual representation of the 3D blocks of space and the determined one or more risk factors for the geographic location.

In some cases, the one or more risk factors include risk scores for weather predicted within the 3D blocks of space during a defined flight window.

In some embodiments, a method comprises accessing information identifying one or more three-dimensional (3D) blocks of space at a geographic location, determining a risk factor for the geographic location based on the accessed information, and performing a routing operation for aircraft traveling through the geographic location based on the determined risk factor.

In some cases, the routing operation includes routing the aircraft through the 3D blocks of space when the determined risk factor is below a threshold risk factor associated with adverse weather at the geographic location.

In some cases, the routing operation includes routing the aircraft away from the 3D blocks of space when the determined risk factor meets or is above a threshold risk factor associated with adverse weather at the geographic location.

In some cases, the one or more 3D blocks space are generated by: applying a computational fluid dynamics (CFD) model to the two-dimensional live forecast data to determine a 3D flow at the geographic location and generating the 3D blocks of space based on the determined 3D flow at the geographic location.

In some cases, the accessed information identifies multiple 3D blocks of space; and wherein the risk factor includes a risk factor for each of the multiple 3D blocks of space.

In some embodiments, the systems and methods segment a geographic location into multiple discrete blocks of space within the geographic location, determine an open flight window duration for each block of the multiple discrete blocks of space, select a route through the geographic location that includes a contiguous path of blocks within the geographic location based on the determined open flight window durations, and cause an aircraft to travel through the selected route.

In some cases, determining an open flight window duration for each block of the multiple discrete blocks of space includes receiving two-dimensional (2D) weather data for the geographic location and determining one or more risk factors for each block of the multiple discrete blocks of space.

In some cases, the blocks of space are three-dimensional blocks of space that represent a 3D flow through the geographic location that is determined by applying a computational fluid dynamics (CFD) model to the 2D weather data at the geographic location.

In some cases, a size or quantity of the multiple discrete blocks of space within the geographic location is based on one or more factors associated with routing aircraft through the geographic location, including an overall time window for routing aircraft through the geographic location, a type of aircraft to be routed through the geographic location, a quantity of aircraft to be routed through the geographic location, and/or a weather forecast for the geographic location.

### CONCLUSION

The systems, devices, and components depicted herein provide a general computing environment and network within which the system can be implemented. Further, the systems, methods, and techniques introduced here can be implemented as special-purpose hardware (for example, circuitry), as programmable circuitry appropriately programmed with software and/or firmware, or as a combination of special-purpose and programmable circuitry. Hence, implementations can include a machine-readable medium having stored thereon instructions which can be used to program a computer (or other electronic devices) to perform a process. The machine-readable medium can include, but is not limited to, floppy diskettes, optical discs, compact disc read-only memories (CD-ROMs), magneto-optical disks, ROMs, random access memories (RAMs), erasable programmable read-only memories (EPROMs), electrically erasable e programmable read-only memories (EEPROMs), magnetic or optical cards, flash memory, or other types of media/machine-readable medium suitable for storing electronic instructions.

The network can be any network, ranging from a wired or wireless local area network (LAN), to a wired or wireless wide area network (WAN), to the Internet or some other public or private network. While the connections between the system and other aspects are shown as separate connections, these connections can be any kind of local, wide area, wired, or wireless network, public or private.

Further, any or all components depicted in the Figures described herein can be supported and/or implemented via one or more computing systems or servers. Although not required, aspects of the various components or systems are described in the general context of computer-executable instructions, such as routines executed by a general-purpose computer, e.g., mobile device, a server computer, or personal computer. The system can be practiced with other communications, data processing, or computer system configurations, including: Internet appliances, hand-held devices (including tablet computers and/or personal digital assistants (PDAs)), all manner of cellular or mobile phones, multi-processor systems, microprocessor-based or programmable consumer electronics, set-top boxes, network PCs, mini-computers, mainframe computers, and the like. Indeed, the terms “computer,” “host,” and “host computer,” and “mobile device” and “handset” are generally used interchangeably herein and refer to any of the above devices and systems, as well as any data processor.

Aspects of the system can be embodied in a special purpose computing device or data processor that is specifically programmed, configured, or constructed to perform one or more of the computer-executable instructions explained in detail herein. Aspects of the system may also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices.

Aspects of the system may be stored or distributed on computer-readable media (e.g., physical and/or tangible non-transitory computer-readable storage media), including magnetically or optically readable computer discs, hard-wired or preprogrammed chips (e.g., EEPROM semiconductor chips), nanotechnology memory, or other data storage media. Indeed, computer implemented instructions, data structures, screen displays, and other data under aspects of the system may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Portions of the system may reside on a server computer, while corresponding portions may reside on a client computer such as a mobile or portable device, and thus, while certain hardware platforms are described herein, aspects of the system are equally applicable to nodes on a network. In an alternative embodiment, the mobile device or portable device may represent the server portion, while the server may represent the client portion.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of implementations of the system is not intended to be exhaustive or to limit the system to the precise form disclosed above. While specific implementations of, and examples for, the system are described above for illustrative purposes, various equivalent modifications are possible within the scope of the system, as those skilled in the relevant art will recognize. For example, some network elements are described herein as performing certain functions. Those functions could be performed by other elements in the same or differing networks, which could reduce the number of network elements. Alternatively, or additionally, network elements performing those functions could be replaced by two or more elements to perform portions of those functions. In addition, while processes, message/data flows, or blocks are presented in a given order, alternative implementations may perform routines having blocks, or employ systems having blocks, in a different order; and some processes or blocks may be deleted, moved, added, subdivided, combined, and/or modified to provide alternative or subcombinations. Each of these processes, message/data flows, or blocks may be implemented in a variety of different ways. Also, while processes or blocks are at times shown as being performed in series, these processes or blocks may instead be performed in parallel, or may be performed at different times. Further, any specific numbers noted herein are only examples: alternative implementations may employ differing values or ranges.

The teachings of the methods and system provided herein can be applied to other systems, not necessarily the system described above. The elements, blocks and acts of the various implementations described above can be combined to provide further implementations.

Any patents, applications and other references noted above, including any that may be listed in accompanying filing papers, are incorporated herein by reference. Aspects of the technology can be modified, if necessary, to employ the systems, functions, and concepts of the various references described above to provide yet further implementations of the technology.

These and other changes can be made to the invention in light of the above Detailed Description. While the above description describes certain implementations of the technology, and describes the best mode contemplated, no matter how detailed the above appears in text, the invention can be practiced in many ways. Details of the system may vary considerably in its implementation details, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the invention to the specific implementations disclosed in the specification, unless the above Detailed Description section explicitly defines such terms. Accordingly, the actual scope of the invention encompasses not only the disclosed implementations, but also all equivalent ways of practicing or implementing the invention under the claims.

We claim:

1. A system, comprising:
a data reception component configured to receive two-dimensional (2D) weather data for a geographic location;
a block component configured to determine one or more risk factors for three-dimensional (3D) blocks of space associated with the geographic location; and
an action component configured to perform an action associated with the 3D blocks of space.

2. The system of claim 1, wherein the block component generates the 3D blocks of space by:
applying a computational fluid dynamics (CFD) model to the 2D weather data to determine a 3D flow at the geographic location; and
generating the 3D block based on the determined 3D flow at the geographic location.

3. The system of claim 1, wherein the 2D weather data for the geographic location includes multiple 2D data points representing a live forecast at the geographic location.

4. The system of claim 1, wherein the 3D blocks of space include at least one 3D block having a geometrical shape of space positioned within the geographic location.

5. The system of claim 4, wherein the geometrical shape of space is defined by a 3D point of origin and a size metric.

6. The system of claim 4, wherein the geometrical shape of space is defined by a specific shape and a size metric for the specific shape.

7. The system of claim 1, wherein the action component performs an aircraft routing operation based on the determined one or more risk factors for the 3D blocks of space.

8. The system of claim 7, wherein the aircraft routing operation modifies routes of one or more aircraft to pass through the 3D blocks of space when the one or more risk factors include low risk scores for the 3D blocks of space.

9. The system of claim 7, wherein the aircraft routing operation modifies routes of one or more aircraft to avoid the 3D blocks of space when the one or more risk factors include high risk scores for the 3D blocks of space.

10. The system of claim 1, wherein the action component performs a mapping operation to present a visual representation of the 3D blocks of space and the determined one or more risk factors for the geographic location.

11. The system of claim 1, wherein the one or more risk factors include risk scores for weather predicted within the 3D blocks of space during a defined flight window.

12. A method, comprising:
accessing information identifying one or more three-dimensional (3D) blocks of space at a geographic location;
determining a risk factor for the geographic location based on the accessed information; and
performing a routing operation for aircraft traveling through the geographic location based on the determined risk factor.

13. The method of claim 12, wherein the routing operation includes routing the aircraft through the 3D blocks of space when the determined risk factor is below a threshold risk factor associated with adverse weather at the geographic location.

14. The method of claim 12, wherein the routing operation includes routing the aircraft away from the 3D blocks of space when the determined risk factor meets or is above a threshold risk factor associated with adverse weather at the geographic location.

15. The method of claim 12, wherein the one or more 3D blocks space are generated by:
applying a computational fluid dynamics (CFD) model to the two-dimensional live forecast data to determine a 3D flow at the geographic location; and
generating the 3D blocks of space based on the determined 3D flow at the geographic location.

16. The method of claim 12, wherein the accessed information identifies multiple 3D blocks of space; and wherein the risk factor includes a risk factor for each of the multiple 3D blocks of space.

17. A non-transitory, computer-readable medium whose contents, when executed by a computing system, cause the computing system to perform a method, the method comprising:
segmenting a geographic location into multiple discrete blocks of space within the geographic location;
determining an open flight window duration for each block of the multiple discrete blocks of space;
selecting a route through the geographic location that includes a contiguous path of blocks within the geographic location based on the determined open flight window durations; and
causing an aircraft to travel through the selected route.

18. The computer readable medium of claim 17, wherein determining an open flight window duration for each block of the multiple discrete blocks of space includes:
receiving two-dimensional (2D) weather data for the geographic location; and
determining one or more risk factors for each block of the multiple discrete blocks of space.

19. The computer readable medium of claim 18, wherein the blocks of space are three-dimensional blocks of space that represent a 3D flow through the geographic location that is determined by applying a computational fluid dynamics (CFD) model to the 2D weather data at the geographic location.

20. The computer readable medium of claim 17, wherein a size or quantity of the multiple discrete blocks of space within the geographic location is based on one or more factors associated with routing aircraft through the geographic location, including:
an overall time window for routing aircraft through the geographic location;
a type of aircraft to be routed through the geographic location;
a quantity of aircraft to be routed through the geographic location; or
a weather forecast for the geographic location.
